(19) United States
(12) Patent Application Publication
(10) Pub. No.: US 2006/0111994 A1
(43) Pub. Date: May 25, 2006

(54) Set theory based portfolio organization

(76) Inventors: Vijay Kedia, Manhassett, NY (US); Richard W. McGraw, Middle Village, NY (US); Samuel Lev Shteingart, New Rochelle, NY (US)

Correspondence Address: John M. Johnson;Carter, Ledyard & Milbum LLP, 2 Wall Street, New York, NY, 10005, US

(21) Appl. No.: 10/996,889

(22) Filed: Nov. 23, 2004

(51) Int. Cl. G06Q 40/00

(52) U.S. Cl. 705/35

(57) ABSTRACT

A method for organizing a portfolio of financial instruments with a computer comprising providing a first user interface for said portfolio of financial instruments; providing a second user interface for selecting a least one of said financial instruments of said portfolio to form a subset, said subset of said portfolio of financial instruments being formed based on user selected financial criteria of said portfolio of financial instruments in conjunction with at least one of the subset forming rules of financial criteria exclusion, single financial criteria inclusion, and multiple financial criteria inclusion; and reflecting the inclusion of said at least one of said financial instruments of said portfolio within said subset on said first user interface.

### BACKGROUND OF THE INVENTION

This invention applies to portfolio or list trading. The subject invention specifically pertains to a securities execution management system designed for lists trading or single stock trading. There are known execution management systems that allow one to manipulate portfolio lists, a list being a group of equities. An execution management system allows an equity (i.e., stock) trader to send orders to different destinations for execution, such as the NYSE, Nasdaq or other regulated equity exchanges. FlexTrader manufactured by Flex Trade Systems, Inc., of Long Island, N.Y., is an example of an execution management system which uses the FIX engine, a popular financial software protocol. Via FlexTrader the user is able to also create rules or algorithms with which one can trade equity portfolios. FlexTrader specifically relates to algorithmics trading which allows traders to automate their execution. For example, when a stock reaches a certain price, an order is automatically sent by the FlexTrader. FlexTrader is extensively used by hedge funds and financial institutions.

The prior art portfolio data organizational software programs allow one to select characteristics of a particular equity or equities. These characteristics could be a derivative of the underlying stock price, underlying stock movement, underlying volume, for example. However, in order to select any of the above characteristics, a cumbersome and unwieldy “macro” interface has to be employed, and repetitively so far each characteristic desired.

### SUMMARY OF THE INVENTION

The subject invention allows the user to graphically apply a set theory approach to selecting certain equities on the “blotter” screen or on the main screen of the computer application. After selecting certain equities, particular characteristics of these equities, for example, profit and loss, are shown. Next, unique to the subject invention, an action is applied to those equities selected. For example, without the subject invention a user would code separate text macros for each created criteria by which certain equities are selected, e.g., any stock that has a volume greater than 500,000 shares traded today and a price greater than $10. With the subject invention, in contrast, certain criteria or characteristics that apply to a specific equity (such as, for example, its current spread or its current relative performance to the market or to the sector) can be selectively added to a matrix type of user interface by “drag-and-drop” functionality. Within that matrix of selected criteria the user is able to select an equity that has the previously chosen criteria, either regardless of the portfolio location of a specific equity or limited to one or more specific portfolios. The subject invention preferably employs three types of selection criteria, “exclusion”, “inclusion” and “selective inclusion.”

“Inclusion” is a Boolean operator that adds a specific item to a set, for example, all stocks that have a spread less than 5 cents regardless of all of the other criteria that equity also possesses. “Exclusionary” is a Boolean operator that removes a specific item from a set, for example, all stocks that have a spread greater than 0.15 cents, regardless of all of the other criteria that equity also possesses. “Selective Inclusion” requires more than one characteristic being in the matrix, and is a Boolean operator that adds a specific item to a set, provided that two or more criteria are met, for example, all stocks that have a spread greater than 0.02 cents with the ask size being less than 100 shares. The subject invention thus provides the user the ability to see, for example, profit and loss based on a selection criteria that can be applied during different steps of the trading process, i.e., the pre-trade process, the execution process and then the post-trade process. In the pre-trade process one can assess what characteristics most of the portfolio of stocks falls into. During the execution process based on realtime data one can apply or change an action based on the inclusion, exclusion and selective exclusion criteria. In the post-trade process one can again assess a varied analytical data based on certain characteristics: how, for example, does profit and loss rank.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1 is a schematic of the hardware and software modules of the subject invention;

FIG. 2 is a first screen shot of a graphical user interface for an execution management system of the subject invention;

FIG. 3 is a first screen shot of the graphical user interface for the data matrix of the subject invention;

FIG. 4 is a logic flow diagram of the present invention;

FIG. 5 is a screen shot of the control panel of the data matrix of the subject invention;

FIG. 6 is a second screen shot of the graphical user interface for the data matrix of the subject invention;

FIG. 7 is a third screen shot of the graphical user interface for the data matrix of the subject invention;

FIG. 8 is a second screen shot of a graphical user interface for an execution management system of the subject invention;

FIG. 9 is a fourth screen shot of the graphical user interface for the data matrix of the subject invention;

FIG. 10 is a third screen shot of a graphical user interface for an execution management system of the subject invention;

FIG. 11 is a fifth screen shot of the graphical user interface for the data matrix of the subject invention;

FIG. 12 is a fourth screen shot of a graphical user interface for an execution management system of the subject invention;

FIG. 13 is a sixth screen shot of the graphical user interface for the data matrix of the subject invention;

FIG. 14 is a fifth screen shot of a graphical user interface for an execution management system of the subject invention;

FIG. 15 is a seventh screen shot of the graphical user interface for the data matrix of the subject invention;

FIG. 16 is a sixth screen shot of a graphical user interface for an execution management system of the subject invention;

FIG. 17 is a eighth screen shot of the graphical user interface for the data matrix of the subject invention; and

FIG. 18 is a seventh screen shot of a graphical user interface for an execution management system of the subject invention.

### DETAILED DESCRIPTION OF THE PREFERRED EMBODIMENT

1. Hardware Elements and Software Modules

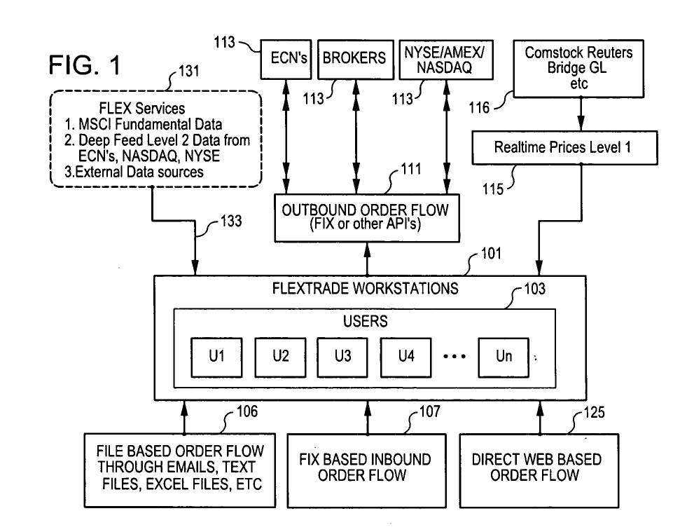

Referring first to FIG. 1, the hardware elements and software modules of the subject invention are described. Multiple execution management system work stations 101 are preferably IBM compatible PC computers each having an Intel Pentium-based central processing unit with 512 MB of RAM and a Linux or Microsoft Windows XP operating system. There are preferably multiple user groups 103 running the above workstations, preferably interconnected by a local area network (LAN), with each user group 103 comprised of individual users U₁, U₂ . . . Uₙ. If FlexTrader is the execution management system software program of choice on workstations 101, each of user U₁, U₂ . . . Uₙ can tailor the graphical user interface of the FlexTrader software program to suit their personal preferences. An API (application program interface) communicates with the users U₁, U₂ . . . Uₙ of each user group 103 and sends and receives data pertaining to, for example, populating financial data columns or obtaining the results of calculations or the results of actions.

Inbound order flow module 107, operating under the FIX protocol engine, accepts incoming orders described further below. There is network interconnection between inbound order flow module 107 and a software router that is preferably a private network or proprietary network such as TNS (transaction network services) that is a secure high speed connection widely used in the financial industry. Via inbound order flow 107 FIX clients communicate via the TNS network and send FIX-based messages to execution management system workstations 101. Also in electronic communication with inbound order flow module 107 is OMS (order management system) such as, for example, Network Cloud, McGregor, Bloomberg, Brass NYFix, Trade Route, which allows the OMS client to review their portfolios.

Direct web based order flow 125 is in communication, or has connectivity with, execution management system 101, that allows web based order flow 125 to interconnect with the execution management system workstations 101 via front end of the web client.

Order match module 111 includes a FIX-based engine that is in electronic communication with execution management system workstations 101. Order match module 111 is also in electronic communication with other FIX-based trade destinations 113, such as NYSE, and other brokers or ECNs such as Arca, Island, Brut, Instinet, for example. Trade orders are sent from execution management workstations 101 to order match module 111, then to one of the trade destinations 113 where the orders are filled or another trade based action happens, which is then relayed back to order match module 111 with the result being displayed on execution management workstations 101, then continuing to the desired one of the user groups 103 and, finally, to the appropriate one of the users U₁, U₂ . . . Uₙ. API 135 is in communication with order match module 111 and monitors outbound order data.

Next referring to real time pricing module 115, which is a consolidator and data re-formatter of prices from different destinations, real time pricing module 115 communicates to execution management system workstations 101, and specifically to a specific ones of user U₁, U₂ . . . Uₙ. Data vendors 116, such as Reuters and Comstock, provide real time prices on equities and other types of securities to real time pricing protocol 115.

Flex services module 131 communicates with execution management system workstations 101 via transaction network services 133 (TNS), an example of a viable proprietary data network. Flex services module 131 provides: fundamental data, (Morgan Stanley Country Index) a classification of securities bases on industry and sector level; deep feed level 2 data, the specific information from a price feed similar to real time pricing module 115; and level 1 data, again similar to pricing module 115 data and the basic view of security prices.

File based order input 106 is the input of external trade files (or list of trades to be executed) in, for example, text, Excel or ASCII format, to users U₁, U₂ . . . Uₙ. File based order input 106 is thus in communication with execution management system workstations 101 in order to facilitate trading.

2. Execution Management System Graphical User Interface

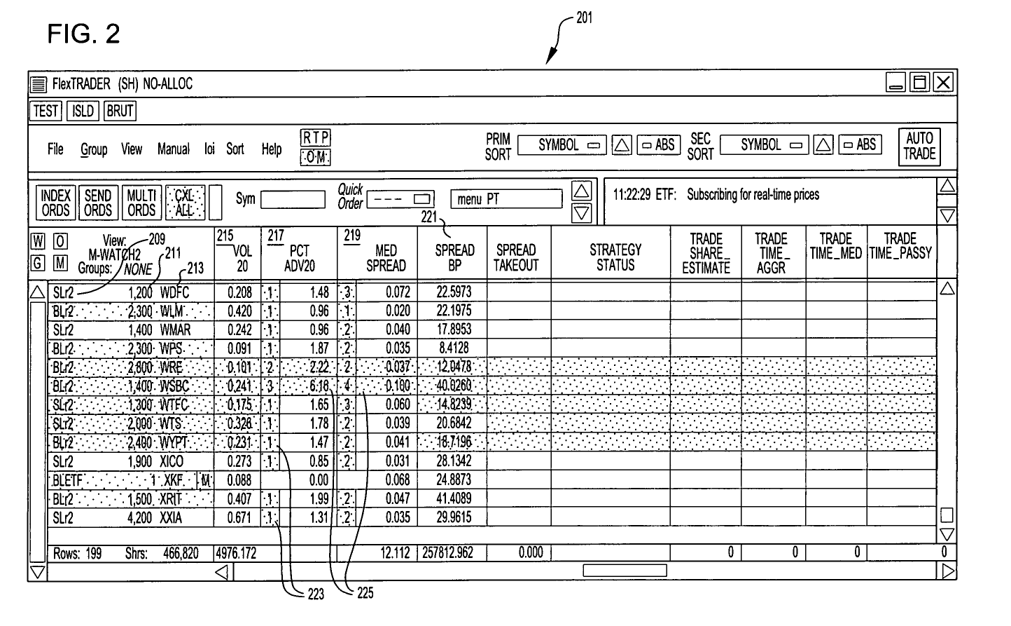

Next referring to FIG. 2, an example of a graphical user interface is described for an execution management system, in this example FlexTrader, within which the software of subject invention resides. First referring to 201 the main screen of the EMS program is shown. The main FlexTrader “blotter” screen 201 is part of the execution management system described in FIG. 1. The “blotter” is configurable to allow the user to perform specific actions. These actions can be unilateral actions or they can be actions on specific rows of the blotter. The actions performed include computation of a certain value, a screen snap shot, or an actual travel action such as “send an order down to the floor,” “correct an order,” “cancel an order” for example.

Spreadsheet 207 of blotter 201 lists portfolio information in rows identified by, for example, portfolio name (SLR2) 209, the number of shares (1,200) 211 and specific symbol (WDFC) 213. Further regarding portfolio name 209, one possible nomenclature denotes SL as “sell long”, SH for “sell short”, BL for “buy long” and BC for “buy cover”, with r2 in all instances being the specific portfolio identifier.

Columns intersect the above described portfolio rows of spread sheet 207, and each column represents a certain characteristics associated with that specific portfolio. In the first column 215, VOL20, is a measurement of that particular portfolio's volatility per stock. Second column 217, PCT ADV20, is the percentage of an equity's shares to trade relative to its average 20 day volume. For example, if over the last 20 days 100,000 shares are traded on the average a day, then 1,200 shares (element 211) is 1.2% of an average day. Third column 219, MED SPREAD, denotes, on the average, the difference between the buying and selling price of the security. Fourth column 221 denotes SPREAD BP, which is calculated by taking that median spread value and dividing it by the stock price. This value is shown in basis points which is 1/1000 (or 0.1 percent) of the median spread. It is to be understood that the above four share characteristics 215-221 are just examples of share characteristics, they are not intended to be all inclusive. Other characteristics include, by not limiting example, the percent change in the stock price from yesterday's close, profit and loss information in either dollars, basis points or cents per share, difficulty to trade factors, and sector or industry grouping (i.e., technology, a biochemical, biotechnology industry group).

Again referring to column 217, PCT ADV20, there are highlighted ranking numbers 223 (i.e., numbers 1, 2 or 3) in the same cell to the left of the actual PCT ADV number. “Ranking” of ranking numbers 223 is broadly defined as a grouping of specific attributes. For example, all the values in second column 217, PCT ADV20, that are above 1 and below 2 fall into rank 1, and all the values that are above 2 and below 4 fall into rank 2.

Next referring to highlighted rows 225 of a plurality of portfolios, highlighted rows 225 are highlighted by left clicking the mouse, holding the left mouse down, and dragging across the desired number of rows. Alternatively, a computer keyboard button tied to a specific portfolio or to a predetermined characteristic of some portfolios can highlight specific portfolio rows. Next, the highlighted rows 225 can be acted upon by the execution management system software by implementation by the user of one or more of command lines 205 to invoke the computation action associated therewith. The result, in one possibility, being the population or re-population of ranking numbers 223.

3. Set Theory Based Graphical User Interface

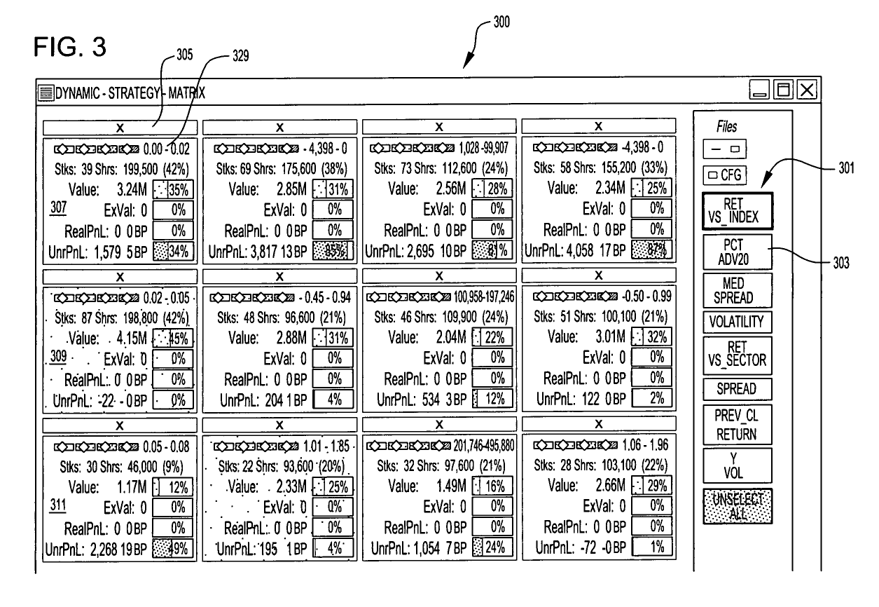

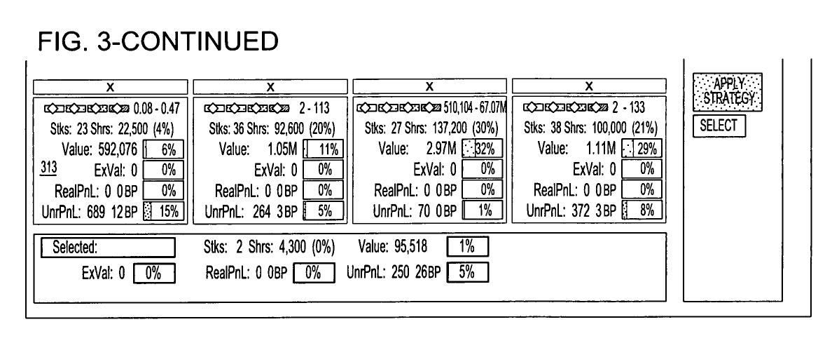

Next referring to FIG. 3, an exemplary graphical user interface for the functionality of the subject invention is shown, the output of the graphical user interface of FIG. 3 having been in part previously discussed in reference to FIG. 2 in reference to ranking numbers 223.

The graphical user interface of FIG. 3 includes a matrix 300 populatable with one or more columns, four of such columns being shown in FIG. 3. Programmable function buttons 301 populate matrix 300 with the column of the execution management system software spread sheet 207 of FIG. 2 associated with that particular programmable function button 301. For example, programmable function button 303, PCT ADV, creates another column in matrix 300 that correlates with, but is not identical to, second column 217, PCT ADV20, (in FIG. 2) of the execution management system software spread sheet 207. The column created in matrix 300 by activating the PCT ADV20 function button 303 is column 305 in FIG. 3. Windows 307, 309, 311 and 313, respectively, in column 305 each represent a different “ranking” that corresponds to ranking number 223 of spread sheet 207 of FIG. 2 with respect to second column 217 thereof. It is important to note that, as these rankings or numbers 223 are altered as further described below by operation within windows 307, 309, 311 and 313 of matrix 300, the aforesaid ranking numbers 223 are likewise altered on spread sheet 207 of FIG. 2.

More specifically, window 307 has a data summary of all of the securities that have a rank of 1 based on ranking number 223 of spread sheet 207 of FIG. 2. Thus, in window 309, 39 shares have a 1 rank, the total number of shares is 199,500, and the percentage of all the stocks on spread sheet 207 that are in window 309 is 42%. The value (the last price times the number of shares), the executed value (value of the total numbers that have been executed), the real P&L and unreal P&L are all also provided. Finally, in window 309, boundary conditions 329 are shown. Boundary conditions 329 do not denote the theoretically acceptable range of stocks that could possibly satisfy a 1 rank, but instead denotes the actual minimum and maximum value of actual stocks that populate rank 1 of window 309 (MED_SPREAD).

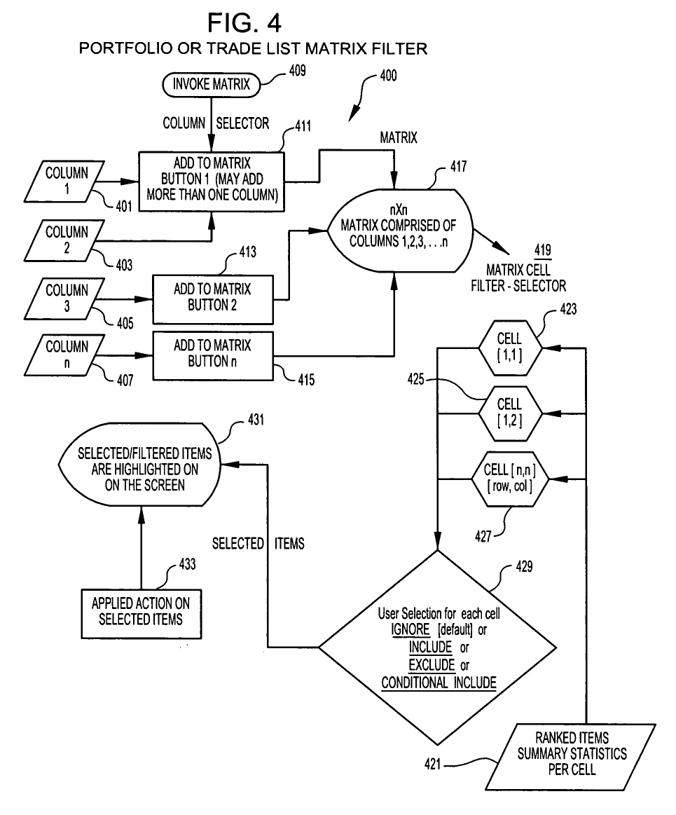

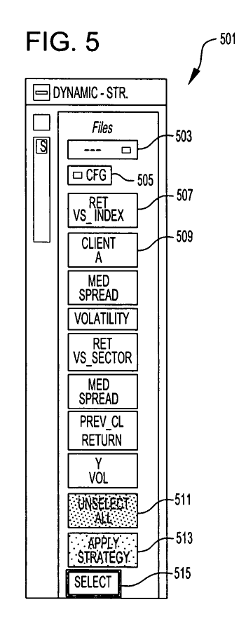

FIG. 4 is a software logic flow diagram of the matrix filter 400 of the subject invention. Block 401 represents a unique column on the blotter (201 of FIG. 2) such that each entry in the column may (or may not) have a rank from 1, 2, 3 or 4, for example. More than one column, blocks 401 through 407, may be ranked on the blotter 201. Block 409 invokes the matrix filter by, for example, an actuation button on the blotter 201. The matrix filter 400 is a graphical user interface described in detail, for example, as 501 in FIG. 5 that allows data specific and function specific information filtering. Matrix population functions 411 through 415 corresponds to actuation buttons further described in relation to the matrix filter 400 (501 of FIG. 5), and provide the population of matrix filter 501 with the related blotter 201 columns satisfying the functionality of 401 through 407 upon activation of the appropriate actuation button of matrix filter 501. Matrix population functions 411 through 415 populate the matrix filter 400 as shown at block 417. At block 419 the matrix cell selector, which encompasses filter blocks 423, 425 and 427 is shown. At blocks 423, 425 and 427, specific individual cells of the matrix are “called.” Specifically, block 423 calls cells 1, 1, block 425 calls cell 1, 2 and block 427 calls cell n, n with the first number denoting the row and the second number denoting the column of the “called” cells of the matrix. It is to be noted that only three “called” cell groups are shown for purposes of example, and more or less cells can be “called.” The cell groups that are “called” at 423 through 427 correspond to the functionality customized for the subject matrix filter; in this example the functionality is based on the “ranking” 1-4 of the data of the individual cells, as divided by the different columns, of blotter 201 as further described below.

In addition Summary Information Per Cell block 421 provides the number of cells of blotter 201 (i.e., data locations) that fit into that criteria. For cell 1, 1 (i.e., all the data of blotter 201 in column 1 that have rank 1) if there are 10, the summary statistic can provide, for example average value of that data of that matrix cell. Other summary statistics of block 201 can include realized and un-realized p&l, the value of the stocks that fall into that specific matrix cell, and so forth. As described in further detail below each individual matrix cell has control buttons (“radio buttons”) that allow matrix filter 400 to “ignore”, among other functions, the information present in any matrix cell whereby matrix filter 400 does not include blotter 201 data of that matrix cell in its processing.

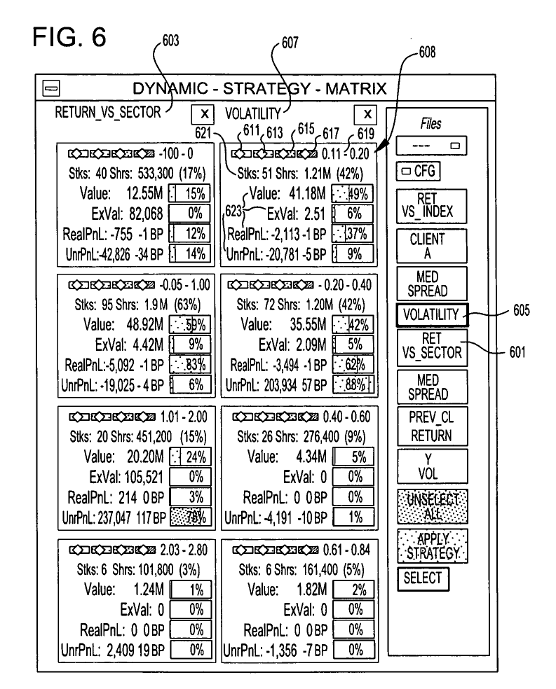

As further shown in selection block 429, the aforesaid radio buttons can indicate any of “ignore” (which is the default mode), “include”, “exclude”, or “conditional include” matrix filter 400 functionality. Preferably, a screen color is associated with each of the above functionality of matrix filter 400 on both blotter 201 and matrix filter (600 of FIG. 6, for example). For “ignore” there is no color highlighted. “Include” is a green color, “exclude” is a red color, and “conditionally include” is a yellow color, for example.

Also, Summary Statistics Aggregate are complied in the same manner as Summary Information per cell 421, and additionally, the number of items that are in each of the “include”, “exclude”, and “conditionally include” categories are provided. At block 431 the above described color-based highlighting based on the applied functionality (“ignore”, “include”, “exclude” and “conditionally include”) is implemented. At Apply Action block 433, actions to the underlying equities present in the color-based highlighted cells of the matrix filter and blotter 201 are implemented. These actions include, by non-limiting example, order cancellation buying, selling or analytical non-trade, actions.

FIG. 5 shows an exemplary matrix filter control panel 501 of the subject invention, the matrix filter, itself, being not populated with data. File panel 503 denotes the files that have been loaded into the subject matrix control panel 501. File panel 503 can also denote a sequential file listing of an entire group of files.

Configuration button 505 allows the configuration of the remainder of buttons (for example buttons 507 and 509) of matrix control panel 501. For example, button 507 is named RET VS. INDEX is created by actuation of configuration button 505 in conjunction with the appropriate script commands programs which will facilitate the addition of a return versus index column into the matrix filter. Likewise, the CLIENT A button 509 can drop in the percent ADV20 column, as well as the return versus sector column into the matrix filter based on actuation of configuration button 505 and associated script commands.

Button 511 has the “unselect all” functionality to return the matrix filter data to the default starting condition. Apply strategy button 513 allows the user to apply a specific action on selected matrix filter data items. Select button 515 allows the user to reselect all the actions that have been made to the matrix filter data if, for example, there has been manual intervention where the user has un-highlighted some items and would like to reapply the selection mechanism.

Next referring to FIG. 6, a populated matrix filter is shown having two columns that were dropped via the two buttons RET VS. SECTOR 601 which is the return versus sector that added the column of RETURN VERSUS SECTOR 603, and VOLATILITY 605 that dropped in VOLATILITY column 607. Now referring to individual matrix cell 608, (cell row 1, column 2 or 1, 2) this cell, like all cells have 4 radio buttons, only one of which can be selected at any given time. The “ignore” radio button 611 is the default radio button that active when the column is initially added. Radio button 613, the “inclusion” radio button, may be, for example, denoted by a green color. Radio button 615 may be, for example yellow and represents “selective inclusion”. Radio button 617 may be, for example, red and represents “exclusion”. Range indicator 619 indicates the high and low of the items that fall into cell 1, 2 of the VOLATILITY column 607, in this instance from 0.11 to 0.20. Equity number indicator 621 displays the number of equities that fall into cell 1, 2 in the VOLATILITY column 607 (there are 51), as well as the total number of shares (which is 1.21 million) and the percent of equities ranked that fall in cell 1, 2 (42 percent). Data window 623 displays other characteristics for the equities that fall into cell 1, 2, specifically (but not-limiting) the value, the executed value, realized p&l (profit and loss) and un-realized p&l, in both numerical values as well as in percentages. These four items of data window 623 are also configurable by the users to add additional items to those four items, or instead of those four items, such that more or less than four items can be dispatched.

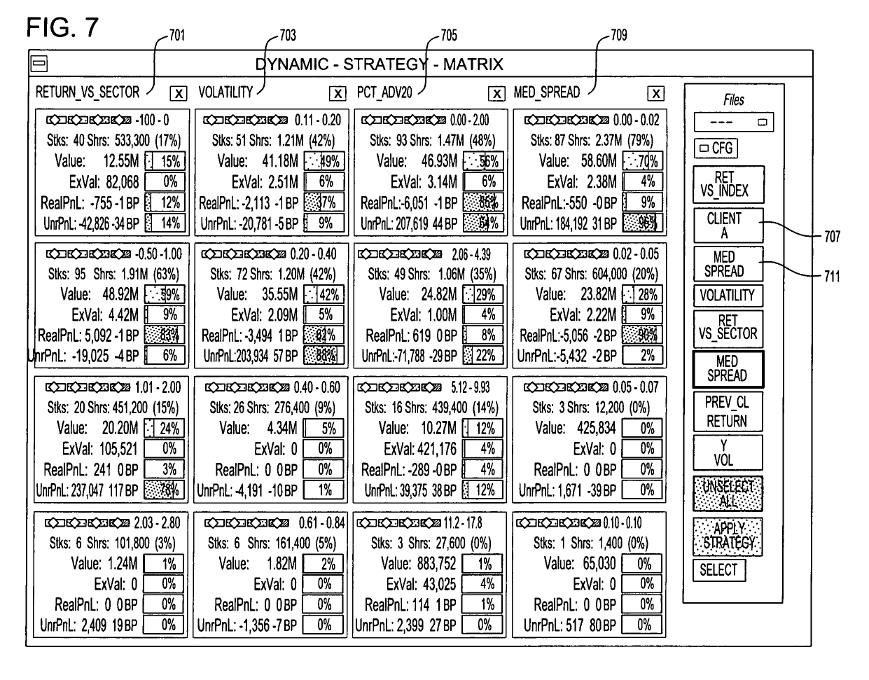

Next referring to FIG. 7 the addition of two more columns to the matrix of FIG. 6 is now described. First cross-referencing FIG. 6, FIG. 7 also shows the RETURN VERSUS SECTOR column, denoting it as 701 instead of 603. Additionally, FIG. 7 also shows the VOLATILITY column denoting it as element 703 instead of element 607.

Two additional columns are PCTADV20 705, which was dropped in by actuating CLIENT A button 707, and column MED_SPREAD 709 which was dropped in by actuating MED_SPREAD button 711. It is to be noted that all of columns 701 through 709 have the first radio button, i.e. the “ignore” radio, button activated such that no functionality has been applied to any of these columns in FIG. 7.

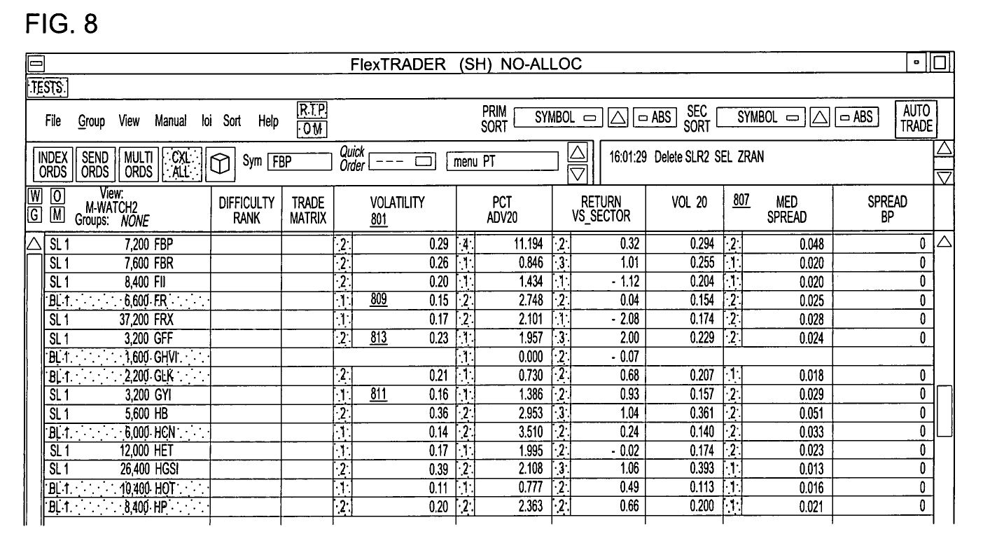

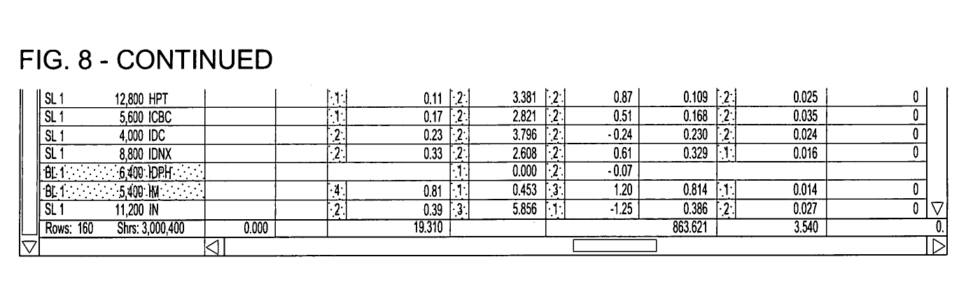

Next referring to FIG. 8, the blotter 801 (cross referenced as 201 of FIG. 2) is shown in its initial condition or state prior to any functionality being implemented via the matrix filter panel 501. This initial condition was previously noted in regard to FIGS. 6 and 7 where it had been stated that these Figures denoted the matrix filter prior to initiation of functionality therein. The blotter rows 801 are not highlighted because FIG. 8 refers to the effect of the matrix filter on blotter 801, and there is no functionality at present.

VOLATILITY column 801 is directly related to the VOLATILITY column 607 and the cell 608 of FIG. 6 where equities of rank 1 are located. Likewise, blotter cells 809 and 811 both relate to matrix cell 608 on FIG. 6, blotter cell 813 relates to the matrix cell immediately below 608, which is unlabeled. Also, PCT ADV20 803 directly relates to PCT ADV20 in FIG. 7 RETURN vs. SECTOR 805 relates to 701 and MED_SPREAD 807 refers to MED_SPREAD 709. Note that each of these columns (VOLATILITY 801, PCT ADV20 803, RETURN vs. SECTOR 805 and MED_SPREAD 807) have blotter cells, (e.g. 809, 811, 813) each of which have a ranking from 1-4 that denotes the specific matrix cell, based on row number of the particular matrix column, that the blotter cell will populate.

More specifically the numerical ranking of the blotter cells is implemented in one embodiment by a subroutine that takes stock or trading data or other reference data (calculated or historical) and partitions the equities amongst a predetermined number of levels based upon the location of the equities within a hierarchy as defined by the characteristics coded in the subroutine.

Blotter cells 809 and 811 are ranked 1 (note the number 1 in the cells) and thus fit into matrix cell 608 of FIG. 6 which has been specifically configured to accept all blotter cells in the VOLATILITY column 801 having a rank of 1. Blotter cell 813 displays a rank of 2 which would place this data into the matrix cell below matrix cell 608. The ranking information for each individual blotter cell, as denoted in the lower left of the blotter cell, reflects the row number for the specific column in the matrix that defines the equity distinction of that column i.e., VOLATILITY. The blotter cell rankings thus control population of the data into the matrix cell of the cross-referenced (i.e., rank 1) row number of that column.

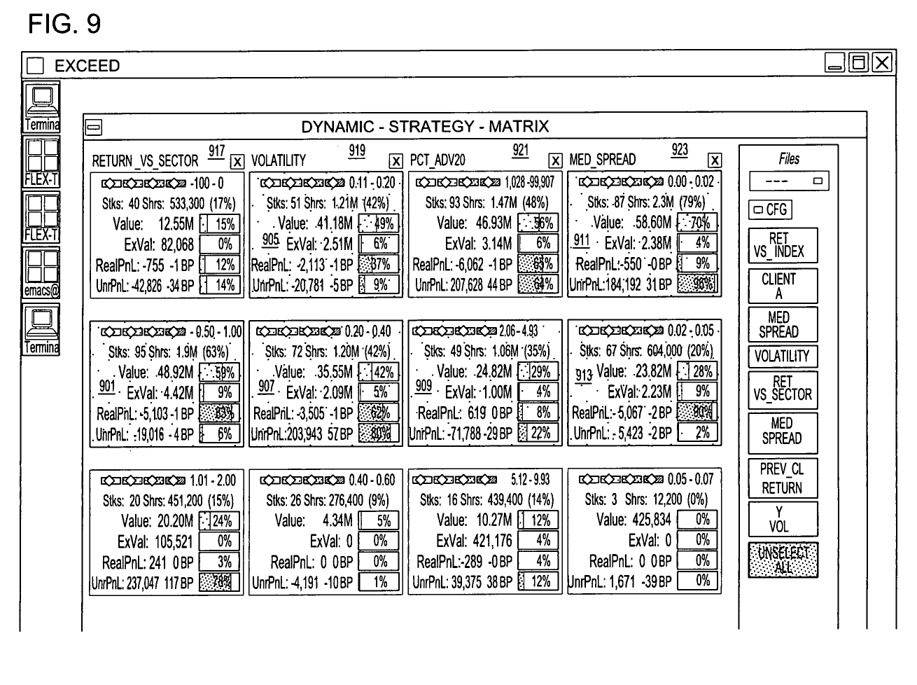

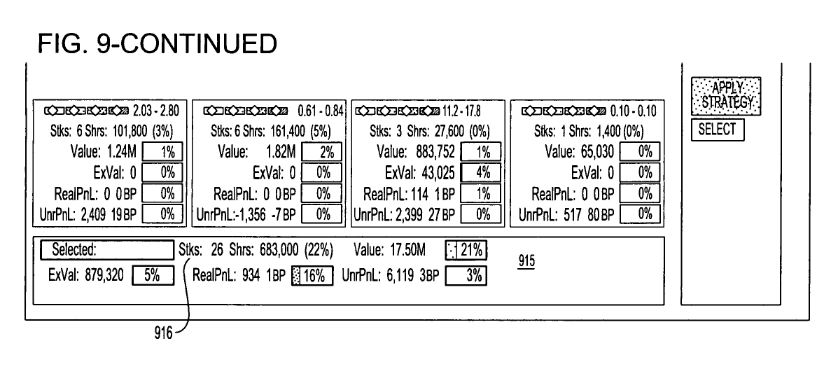

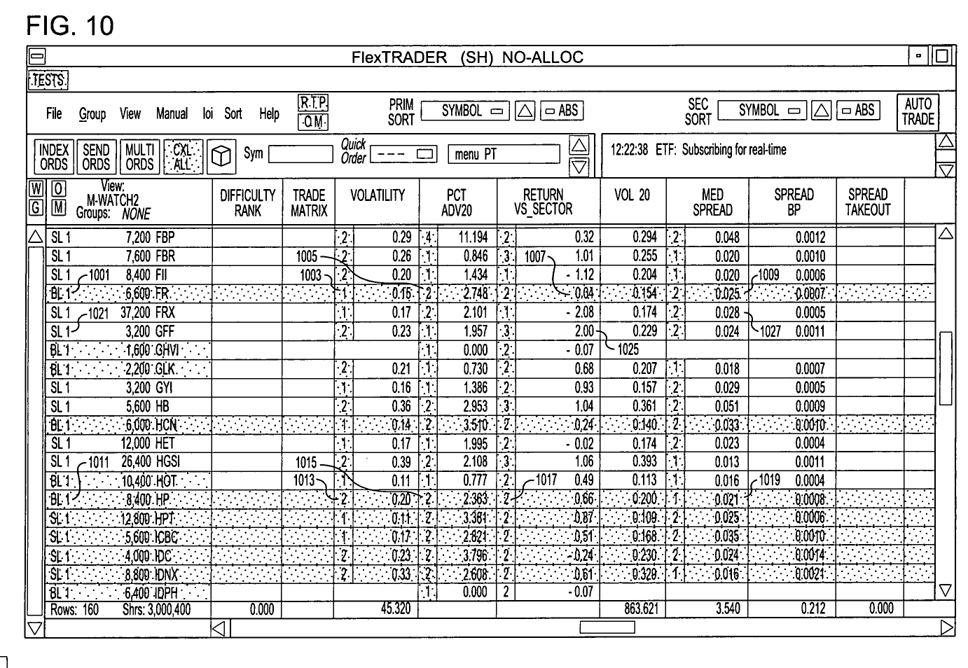

Next referring to FIGS. 9 and 10, FIG. 9 displays of the matrix filter of the subject invention in which the “conditional inclusion” functionality has been executed. Cells 901, 905, 907, 909, 911 and 913 have been selectively added, as shown by the yellow highlighting of these cells. Any matrix cells that are selected have to satisfy the following criteria: the matrix cells in the return versus sector column (RETURN_VS_SECTIOR) 917 have to be ranked 2 (as is matrix cell 901), the matrix cells in the volatility column (VOLATILITY) 919 have to be of rank 1 (as is matrix cell 905) or rank 2 (as is matrix cell 907), the matrix cells in the percent ADV20 column 921 have to have a rank of 2 (as is matrix cell 909) or the matrix cells MED_SPREAD column 923 have to have rank 1 or 2 (the rank of matrix cell 911 being 1 and the rank of matrix cell 913 being 2). All of these rankings have been selected based on the actuation of the “conditional inclusion” radio buttons within the previously mentioned boxes 901, 905, 907, 909, 911 and 913. This radio button of “conditional inclusion” in the present embodiment, which is a non-limiting example, and as further described below, provides, for example, a yellow coloring on the users screen, as stated above.

All the equities which satisfy the above criteria and are thus present in matrix cells 901, 905, 907, 909, 911 or 913 are shown in selected stock listing window 916 of summary information area 915 (e.g., 26 stocks shown). Selected stock listing window 915 also shows “value,” “realized profit and loss” and “unrealized profit and loss.” In addition to the implementation of selected criteria, as noted above, the present invention also encompasses the notation of unselected criteria within the parameters detailed above for selected criteria.

Next referring to FIG. 10 which shows the main blotter 201 as highlighted based upon the “conditional inclusion” matrix filter selection criteria of FIG. 9, highlighted blotter row 1001 includes blotter cell 1003 which is a cell of rank 1 that thus falls into matrix column 919, matrix cell 905 of FIG. 9. Likewise, blotter cell 1005, having a rank 2, satisfies the criteria of matrix cell 909. Blotter cell 1007 which shows a ranking of 2 satisfies the criteria of matrix column 917, matrix cell 901. Blotter cell 1009, with a rank of 2 satisfies the criteria of matrix cell 913, thus again being included. It is important to thus note that blotter row 1001 is highlighted because all of the blotter cells in blotter row 1001 that were analyzed (i.e., blotter cells 1003, 1005, 1007, 1009) for the particular criteria specific to each of these blotter cells actually possessed those criteria. This is the rule set for “conditional inclusion”. Another blotter row highlighted is blotter row 1011 which shows specifically blotter cell 1013, having a rank of 2, satisfies the criteria of matrix column 919 and matrix cell 907. Note that blotter cell 1003 has the rank of 2 while blotter cell 1013 in blotter row 1001, above has a rank of 1, but both blotter rows 1001 and 1011 are highlighted because the ranking can fall into either rank 1 or 2 to satisfy the matrix volatility column 919, (matrix cells 905 and 907). Still referring to blotter row 1011, blotter cell 1015 denotes a rank of 2 which satisfies the criteria of matrix cell 909, blotter cell 1017 has a rank of 2 which satisfies the criteria of matrix cell 901, and blotter cell 1019 satisfies the criteria of matrix cell 911. Blotter cell 1023 is of rank 2 which satisfies the criteria of matrix cell 907, which is selected. But blotter cell 1024, which is of rank 1, corresponds to an unselected matrix cell 910; hence, blotter row 1021 is not highlighted. Also, blotter cell 1025, of rank 3, corresponds to matrix cell 915 which is again unselected, and is another reason for blotter row 1021 not being highlighted. Note that while blotter row 1027 does correspond to selected matrix cell 913, because one or more blotter cells, namely blotter cells 1024 and 1025, do not have selected corresponding matrix cells, blotter row 1021 is not selected or highlighted.

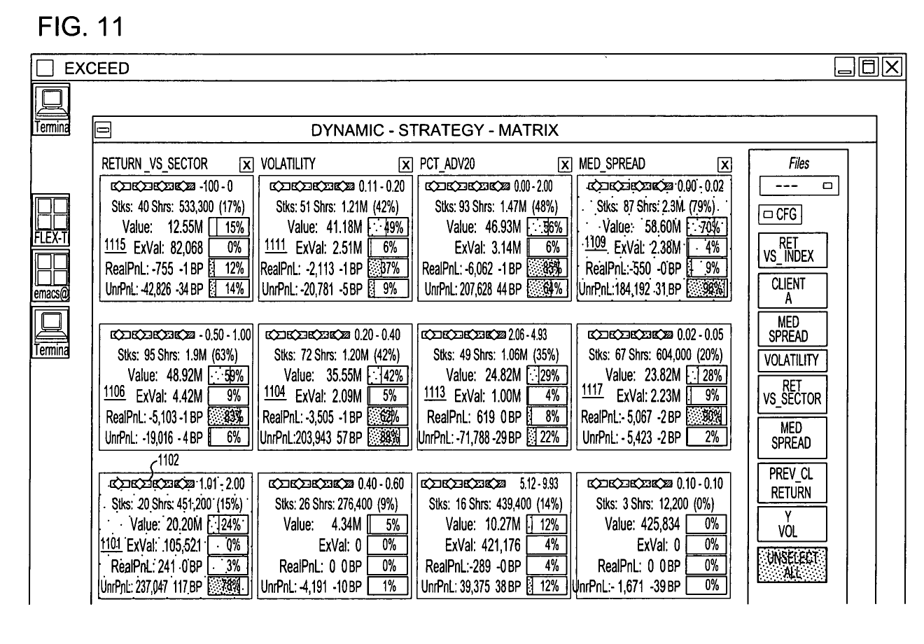

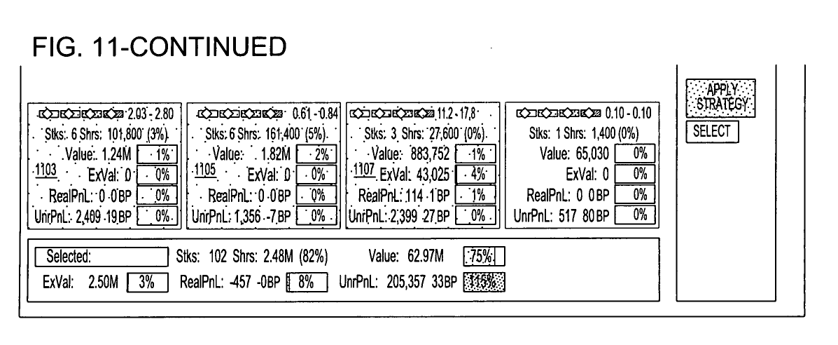

FIG. 11 denotes the “inclusion” function of the subject invention as referenced by depression of radio button 613 of FIG. 6 in the desired cells of the matrix of FIG. 11, described in further detail below. More specifically, the “inclusion” radio buttons of matrix filter cells 1101, 1103, 1105, 1107 and 1109 have been depressed, resulting in these matrix cells to be highlighted for example, green.

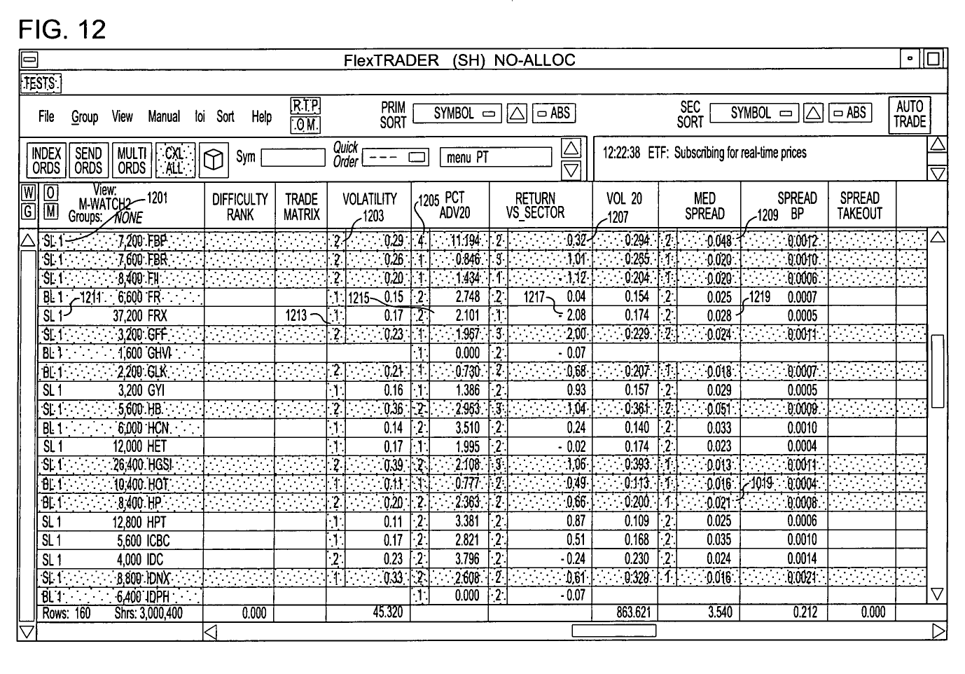

FIG. 12, shows the effect on certain blotter rows and blotter cells thereof by the “inclusion” radio button actuation of FIG. 11, above. Blotter row 1201 is highlighted because blotter cell 1205 corresponds to the “inclusion” criteria of matrix cell 1107, although blotter cell 1203 is not part of any inclusion criteria of any cell of the matrix of FIG. 11 since blotter cell 1203 corresponds to matrix cell 1104. Note that although blotter cell 1203, which corresponds to matrix cell 1104 is not selected, because blotter cell 1205 was selected under the “inclusion” criteria, the entire blotter row 1201 is highlighted, in contrast to the “conditional inclusion” functionality of FIGS. 9 and 10 where each of the blotter cells either had to be “ignored” or had to satisfy the related matrix cell selection criteria in order for the blotter row to be highlighted. The above differentiates the rule set for “conditional inclusion” and “inclusion.”

Further, blotter cell 1207 falls into matrix cell 1106 which is also not selected, and blotter cell 1209 falls into matrix cell 1117 which, again, falls outside of the “inclusion” selection, of the matrix filter of FIG. 11. Yet, as a result of blotter cell 1205 corresponding to the “inclusion” criteria of matrix cell 1107, no other blotter cell in blotter row 1201 need satisfy a selection criteria of a corresponding matrix cell for blotter row 1201 to be highlighted.

Blotter row 1211, in contrast, is not highlighted because none of its blotter cells corresponds to a matrix cell that is selected. For example, blotter cell 1213 falls into matrix cell 1111, which is unselected; blotter cell 1215 falls into matrix cell 1113 which is again unselected; blotter cell 1217 falls into matrix cell 1115 which is also unselected; and blotter cell 1219 which maps to matrix cell 1117 is again unselected. In contrast, if any one of the above matrix cells had been selected, the entire blotter row would be highlighted based on the blotter cell that maps to the selected matrix cell.

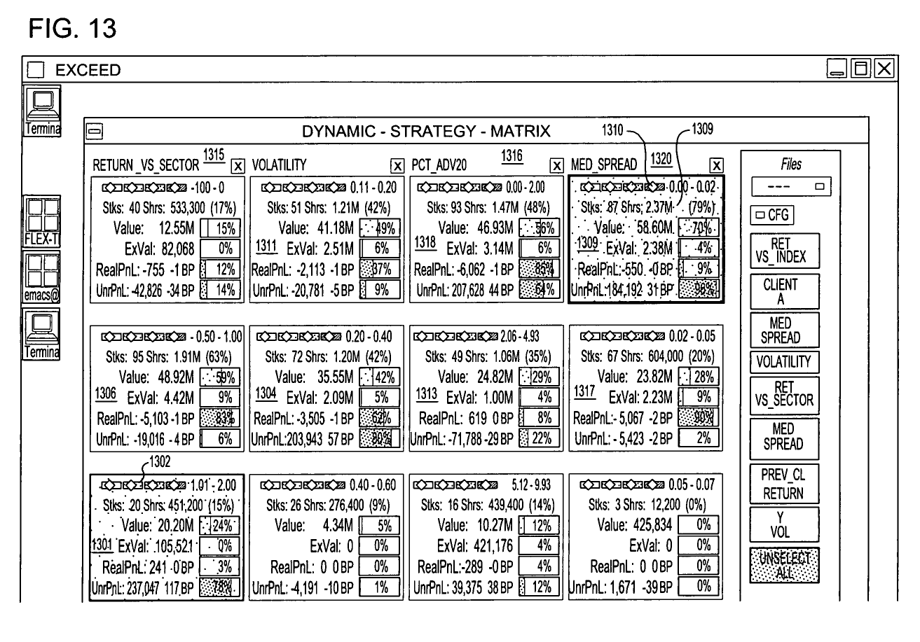

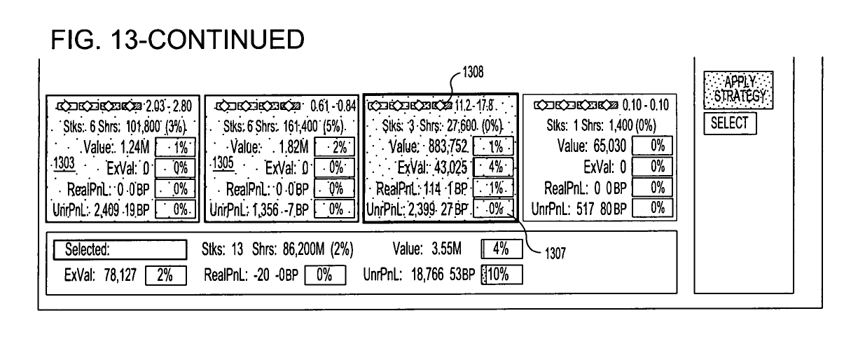

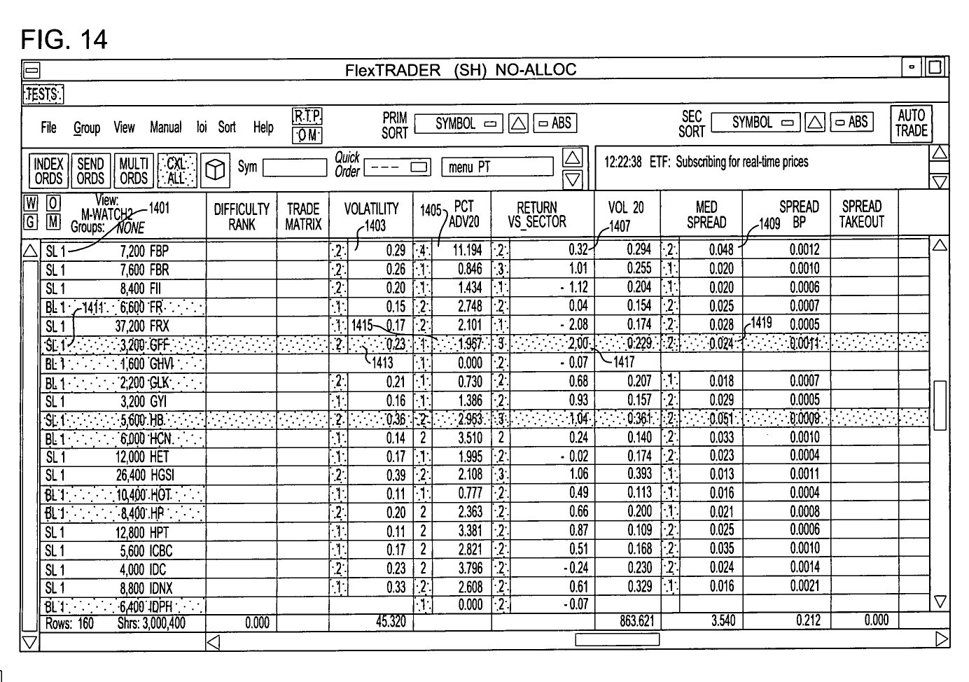

Next referring to FIGS. 13 and 14, the “exclusion” function is discussed. When referring to FIG. 13 like elements in FIG. 13 to those of FIG. 11 are denoted with similar element numbers, i.e., element 1115 in FIG. 11 being equivalent to element 1315 in FIG. 13. Also, it is to be noted that the data previously discussed in FIG. 12 is the same data shown and to be discussed in FIG. 14. Furthermore, elements again discussed in FIG. 14 that had been discussed in FIG. 12 share similar element numbers, i.e., element 1201 in FIG. 12 is equivalent to element 1401 in FIG. 14. First referring to FIG. 13, two alterations from FIG. 11 are present, specifically matrix cell 1307 was changed from “inclusion” (or green color) to “exclusion” (red color) based on actuation of radio button 1308. Likewise, matrix cell 1309, as contrasted with matrix cell 1109, was changed from “inclusion” (green) to “exclusion” (red,) based on actuation of radio button 1310. As a result matrix cell 1301 is “included”, matrix cell 1303 is “included,” matrix cell 1305 is “included” and matrix cells 1307 and 1309 are “excluded.”

The exclusion function thus has the following general rule set: Items that fall into the “exclusion” function are excluded regardless of any other criteria of “inclusion” or “conditional inclusion.” Hence, any equities that fall into matrix cell 1307, which is equivalent to having PCTADV column 1316 and a rank of 4, will be excluded from this selection criteria, and equities in MEDIUM_SPREAD column 1320 with a rank of 1, i.e., matrix cell 1309, will be excluded from this selection criteria regardless of whether any other selection criteria prescribes their inclusion or conditional inclusion.

Next referring to FIG. 14, which corresponds to the selection criteria implemented in FIG. 13, and as differentiated as a result of changing matrix cells 1307 and 1309 from “inclusion” to “exclusion,” the blotter row 1401 is now excluded because blotter cell 1405 falls into matrix cell 1307 which now is mapped as “excluded.” Thus, blotter cell 1405 causes the blotter row 1401 to be not highlighted as opposed to the highlighted blotter row 1201 in FIG. 12. Thus, although blotter cells 1403, 1407 and 1409 satisfy the criteria of being “included” based on: blotter cell 1403 corresponding to matrix cell 1304, which is the “ignore” the selection criteria; blotter cell 1407 being “ignore” based on matrix cell 1306; and blotter cell 1409 being “ignore” as a result of matrix cell 1317, because blotter cell 1405 is interrelated with “excluded” matrix cell 1307, blotter cell 1405 causes blotter row 1401 to be excluded or un-highlighted. Also note that if any of the above matrix selection criteria had been “include” instead of “ignore” the related blotter cells still would have been “excluded” because of the exclusionary condition.

Additionally, if any of the matrix cell was criteria “conditional inclusion” the related blotter cells would still have been “excluded” by the exclusionary conditions. In other words, “exclusion” always takes precedence over “inclusion” “ignore” and “conditional inclusion” functionality.

Next referring to blotter row 1411, which is highlighted, blotter cell 1413, which corresponds to matrix cell 1304, is “ignored”. Blotter cell 1415 corresponds to matrix cell 1318, which is “ignored.” Blotter cell 1417, which corresponds to matrix cell 1301, is “included.” Blotter cell 1419 is “ignored” as it corresponds to matrix cell 1317. As a result of three matrix and corresponding blotter cells being “ignored” and one being “included,” with none “excluded”, (i.e., no blotter cells falling into matrix cells 1307 or 1309) blotter row 1411 is highlighted.

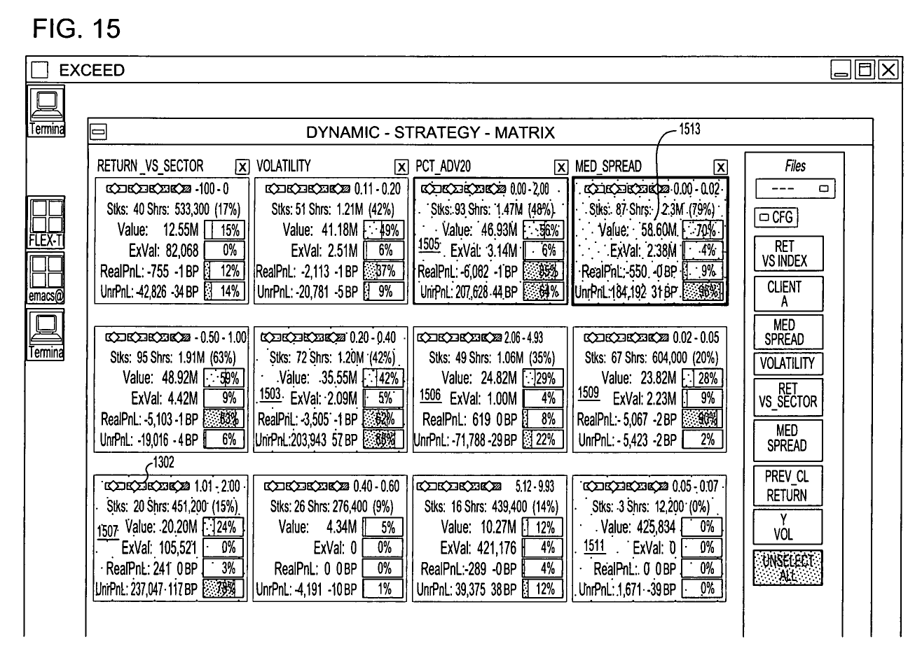

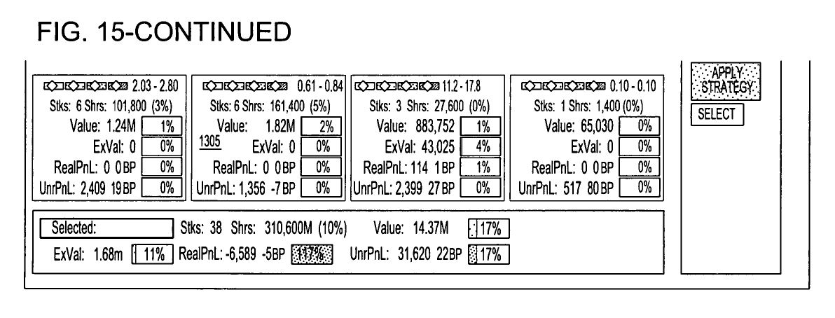

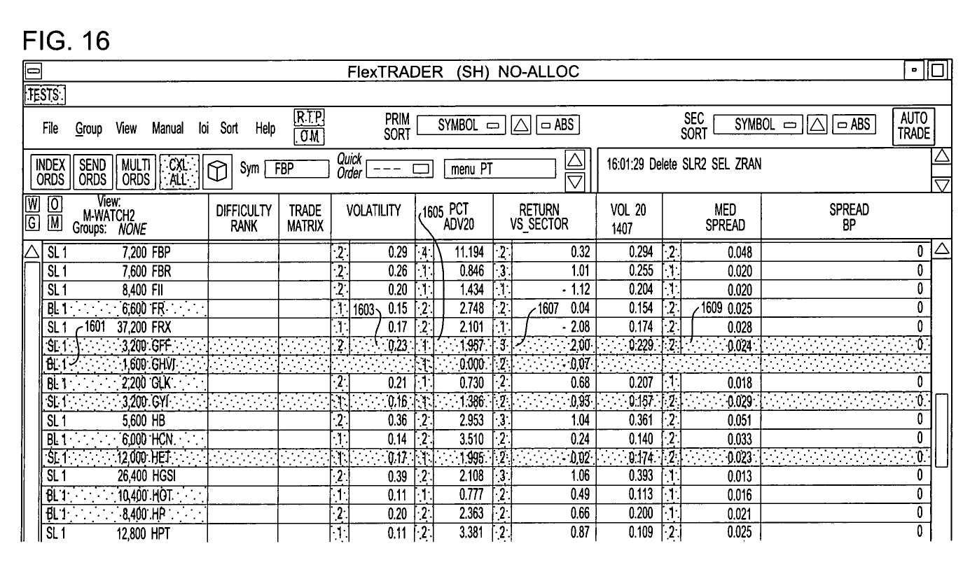

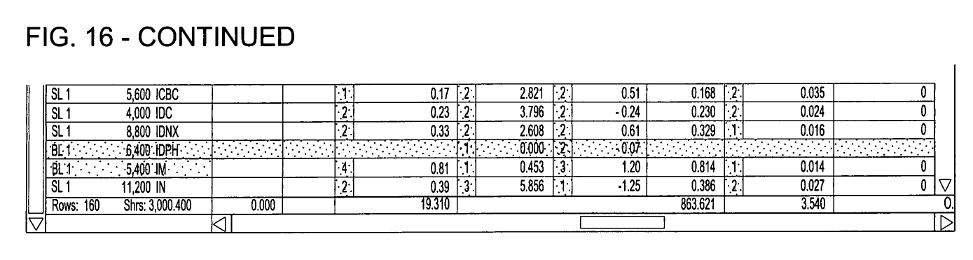

Next referring to FIGS. 15 and 16, the data in the matrix filter of FIG. 15 and the blotter of FIG. 16 is the same data present in FIGS. 10 through 14, however, there is no continuity in the selection of the desired radio button activation in FIG. 15 as compared to the radio buttons selection in FIGS. 11 and 13. Hence the matrix filtering shown in FIGS. 15 and 16 is entirely different from that of FIGS. 11 through 14. Still referring to FIGS. 15 and 16, all three of the functions “conditional inclusion,” “inclusion” and “exclusion” are shown. First referring to FIG. 15, “conditional inclusion” occurs in matrix cells 1507, 1503 and 1511. “Inclusion” is present in matrix cell 1505 and “exclusion” is shown in matrix cell 1513. It is to be noted that all of the above functionalities are accomplished by the depression of the appropriate before described radio button.

Next referring to FIG. 16 blotter row 1601 is a highlighted row because blotter cell 1603 refers to matrix cell 1503 which is “conditionally included”; blotter cell 1605 refers to matrix cell 1505 which is “included”; blotter cell 1607 refers to matrix cell 1507 which is “included” and blotter cell 1609 refers to matrix cell 1509 which is “ignored.” As a result, blotter row 1601 is highlighted because of blotter cell 1605 being “included.”

Because blotter cell 1609 denotes rank 2, not rank 1, it is not “excluded.” Thus, blotter cell 1609 does not fall into a matrix cell category that causes it to be excluded because of “exclusion” functionality or included because of “conditional inclusion” functionality. Alternatively, if blotter cell 1609 was of rank 3 and not of rank 2, blotter cell 1609 would have been another cause for the highlighting (together with blotter cell 1605 being “inclusive”) of blotter row 1601 because blotter cell 1609 would fall in “conditional inclusion” of matrix cell 1511. But, if blotter cell 1609 was of rank 1, which would fall into matrix cell 1513 which is “exclusion,” then blotter row 1601 would have been un-highlighted.

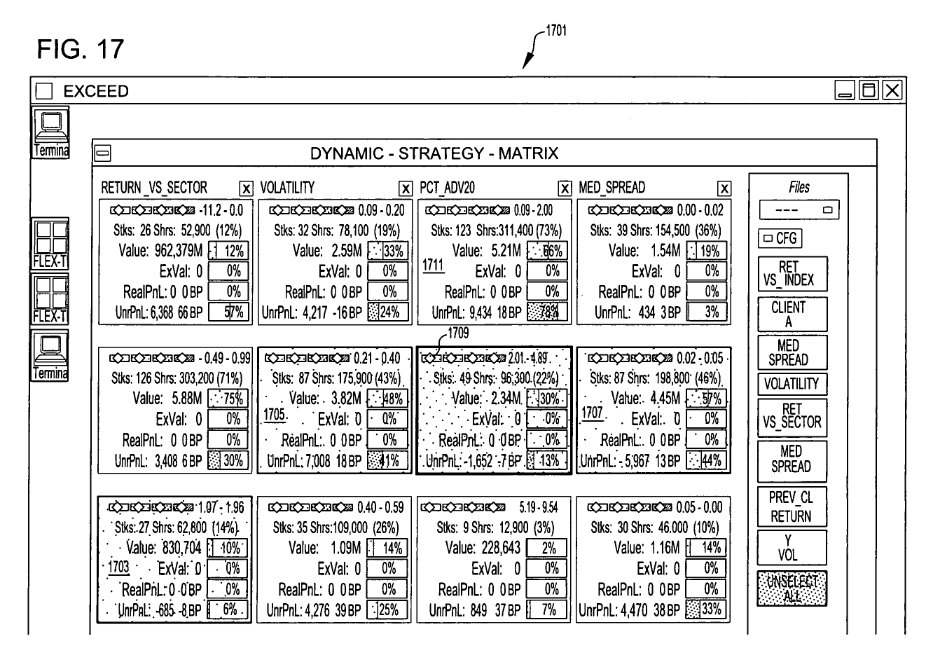

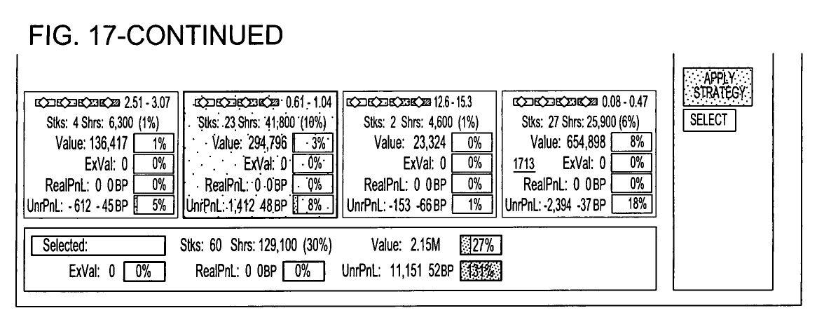

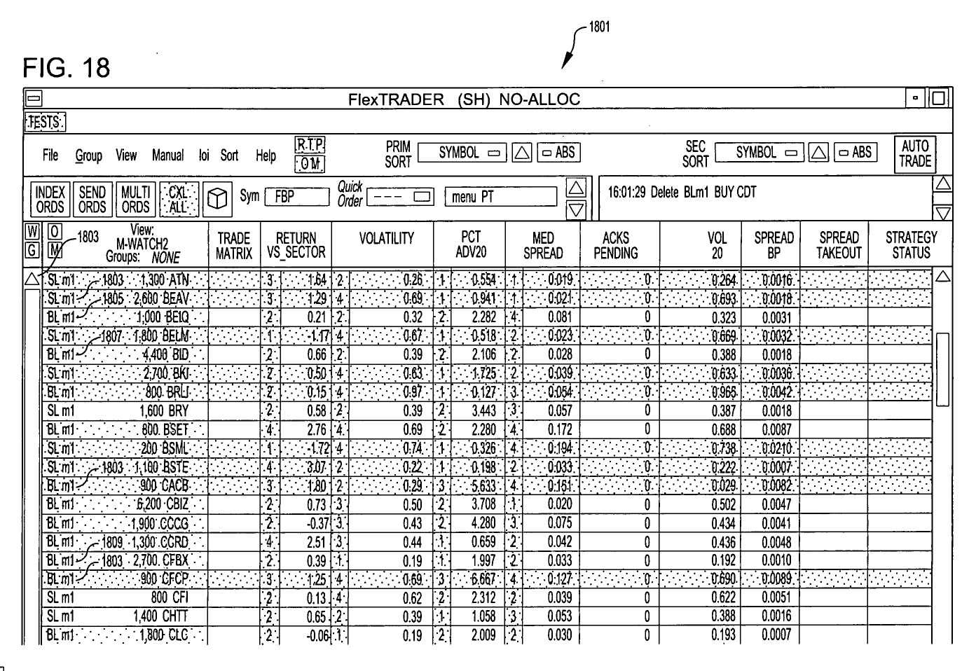

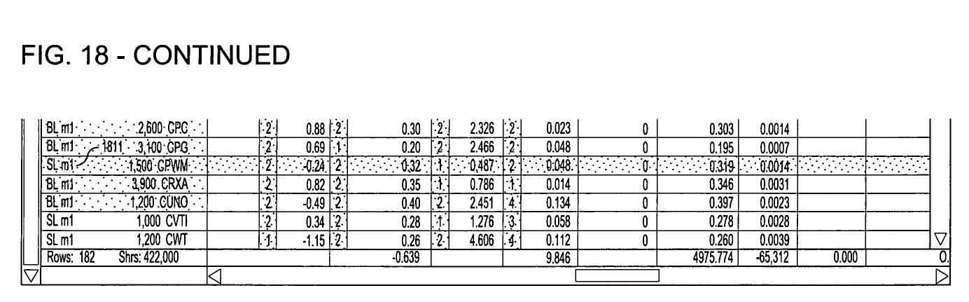

Next referring to FIGS. 17 and 18, all of the “conditional inclusion”, “inclusion” and “exclusion” functions are shown on the same blotter 1801. “Inclusion” is shown for all blotter cells of blotter 1801 that have a rank of 3 in RETRUN_VS_SECTOR. These blotter cells 1803 are highlighted in FIG. 18 and are logically aligned with matrix cell 1703 of matrix 1701 of FIG. 17. The reason that any blotter cells are not highlighted, even if an “inclusion” or “conditional inclusion” functionality applies, is due to the “exclusion” functionality. Blotter cells selected by the inclusion functionality can only be unselected via the exclusion functionality.

“Conditional inclusion” is shown for all items on the blotter 1801 that have a rank of 2 for the VOLATILITY column (logically aligned with matrix cell 1705 of FIG. 17). Conditional inclusion means that all conditional inclusion criteria must be satisfied (i.e. population by an equity in both matrix cell 1705 and matrix cell 1707). If only one conditional inclusion criteria is satisfied (i.e blotter cell 1807 (symbol CHTT) satisfies the criteria where the VOLATILITY rank is 2 but MED_SPREAD is 3, the criteria of selective inclusion is not satisfied. Blotter cell 1807 could still be added provided it falls under inclusion (green) and is not excluded via exclusion (red). Further, selective inclusion of all equities in blotter 1801 that have a rank of 2 for the MED_SPREAD column, logically aligned with matrix cell 17 is shown at 1707.

“Exclusion” of all equities on the blotter 1801 that have a rank of 2 for the PCT_ADV20 column, logically aligned with matrix cell 1709, such as blotter cell 1807 (symbol BID), is next shown. Equities that have a rank of 2 for the PCT_ADV20 column are always excluded regardless of whether they are either conditionally included or included, such as blotter cell 1807 (symbol BID), whose PCT_ADV20 rank is 2 (excluded) and VOLATILITY rank is 2 (conditional inclusion) and MED_SPREAD rank is 2 (conditional inclusion). Hence, “exclusion” always overrides any type on “inclusion”, be it “conditional inclusion” or “inclusion” per se.

Logically, the following filter is employed for the selection mechanism:

(RETURN_S_SECTOR=Rank3) OR

((VOLATILITY=Rank2) AND (MED_SPREAD=Rank2)) AND

(PCT_ADV20 not equal to Rank2)

Still referring to FIGS. 17 and 18, blotter row 1803 ( symbol ATN) is highlighted because it satisfies the logic of “inclusion” matrix cell 1703 where the RETURN_VS_SECTOR rank is equal to 3 and satisfies the logic of matrix cell 1711 (i.e. not in “exclusion” matrix cell 1709) where PCT_ADV20 is not rank 2 (it is rank 1). Logic conditions for “conditional inclusion” matrix cells 1705 and 1707 are not satisfied, but they do not have to be because the logic conditions for “inclusion” matrix cell 1703 is satisfied.

Blotter row 1809 (symbol CFBX) is not selected for the following reasons: It is not included under “inclusion” matrix cell 1703 and is not “conditionally included” under both matrix cells 1705 and 1703 (although 1707 by itself is satisfied, but 1705 is not). Note that blotter row 1809 is not explicitly excluded under the “exclusion” logic of matrix cell 1709.

Blotter row 1811 (symbol CPWM) is selected because it is not “excluded” under the logic of matrix cell 1709 (it falls under matrix cell 1711), and is “conditionally included” under both, not just one of, matrix cell 1705 and 1707.

Blotter row 1805 (symbol BEIQ) is not selected based on PCT_ADV20 having a rank of 2 which satisfies the “exclusion” logic of matrix cell 1709. While any type of “inclusion” would have been overridden by the above “exclusion” functionality, there is also no “inclusion” or “conditional inclusion” functionality because, first, RETURN_VS_SECTOR rank is not 3 (the “inclusion” logic of matrix cell 1703) and, second, MED_SPREAD is not of rank 2 (it is 4) even though VOLATILITY is of rank 2 (i.e., the “conditional inclusion” logic of matrix cells 1705 and 1707 is not met; the logic of matrix cell 1705 is met, but matrix cell 1707 is not since matrix cell 1713 is satisfied instead due to the rank of 4 instead of 2). Recall that both logic conditions of matrix cells 1703 and 1705 need to be satisfied for conditional inclusion to apply.

It will be apparent to those skilled in the art that a number of changes, modifications, or alterations to the present invention as described herein may be made, none of which depart from the spirit of the present invention. All such changes, modifications, and alterations should therefore be seen as within the scope of the present invention.

We claim:

1. A method for organizing a portfolio of financial instruments with a computer comprising:
providing communication by said computer with at least one financial instrument trading exchange for actions regarding said financial instruments;
selecting a least one of said financial instruments of said portfolio to form a subset, said subset of said portfolio of financial instruments being formed based on user selected financial criteria of said portfolio of financial instruments in conjunction with at least one of the subset forming rules of financial criteria exclusion, single financial criteria inclusion, and multiple financial criteria inclusion; and
performing at least one of said actions in said financial instrument trading exchange for at least one of said financial instruments based on said financial instrument being in said subset of said portfolio.

2. The method of claim 1 wherein said financial instruments of said portfolio within said subset are visually hi-lighted.

3. The method of claim 2 wherein said visual highlighting differentiates between said subset forming rules of financial criteria exclusion, single financial criteria inclusion and multiple financial criteria inclusion.

4. The method of claim 1 wherein said user selected financial criteria is obtained from a financial instrument analytical software program.

5. The method of claim 4 wherein said method of organizing a portfolio of financial instruments is a software program interfaced with said financial instrument analytical software program.

6. A method for organizing a portfolio of financial instruments with a computer comprising:
providing a first user interface for said portfolio of financial instruments;
providing a second user interface for selecting a least one of said financial instruments of said portfolio to form a subset, said subset of said portfolio of financial instruments being formed based on user selected financial criteria of said portfolio of financial instruments in conjunction with at least one of the subset forming rules of financial criteria exclusion, single financial criteria inclusion, and multiple financial criteria inclusion; and
reflecting the inclusion of said at least one of said financial instruments of said portfolio within said subset on said first user interface.

7. The method of claim 6 wherein said financial instruments of said portfolio within said subset are visually hi-lighted.

8. The method of claim 6 wherein said visual highlighting differentiates between said subset forming rules of financial criteria exclusion, single financial criteria inclusion and multiple financial criteria inclusion.

9. The method of claim 6 wherein said user selected financial criteria is obtained from a financial instrument analytical software program.

10. The method of claim 9 wherein said method of organizing a portfolio of financial instruments is a software program interfaced with said financial instrument analytical software program.

11. A method for organizing a portfolio of financial instruments with a computer comprising:
providing communication by said computer with at least one financial instrument trading exchange for actions regarding said financial instruments;
providing a first user interface for said portfolio of financial instruments;
providing a second user interface for selecting a least one of said financial instruments of said portfolio to form a subset, said subset of said portfolio of financial instruments formed based on user selected financial criteria of said portfolio of financial instruments in conjunction with at least one of the subset forming rules of financial criteria exclusion, single financial criteria inclusion, and multiple financial criteria inclusion;
reflecting the inclusion of said at least one of said financial instruments of said portfolio within said subset on said first user interface; and
performing at least one of said actions in said financial instrument trading exchange for at least one of said financial instruments based on said financial instrument being in said subset of said portfolio.

12. The method of claim 11 wherein said financial instruments of said portfolio within said subset are visually hi-lighted.

13. The method of claim 11 wherein said visual highlighting differentiates between said subset forming rules of financial criteria exclusion, single financial criteria inclusion and multiple financial criteria inclusion.

14. The method of claim 11 wherein said user selected financial criteria is obtained from a financial instrument analytical software program.

15. The method of claim 14 wherein said method of organizing a portfolio of financial instruments is a software program interfaced with said financial instrument analytical software program.

16. A system for organizing a portfolio of financial instruments with a computer comprising:
a component for providing communication by said computer with at least one financial instrument trading exchange for actions regarding said financial instruments;
a component for selecting a least one of said financial instruments of said portfolio to form a subset, said subset of said portfolio of financial instruments being formed based on user selected financial criteria of said portfolio of financial instruments in conjunction with at least one the subset forming rules of financial criteria exclusion, single financial criteria inclusion, and multiple financial criteria inclusion; and
a component for performing at least one of said actions in said financial instrument trading exchange for at least one of said financial instruments based on said financial instrument being in said subset of said portfolio.

17. The system of claim 16 wherein said financial instruments of said portfolio within said subset are visually hi-lighted.

18. The system of claim 17 wherein said visual highlighting differentiates between said subset forming rules of financial criteria exclusion, single financial criteria inclusion and multiple financial criteria inclusion.

19. The system of claim 16 wherein said user selected financial criteria is obtained from a financial instrument analytical software program.

20. The system of claim 19 wherein said system of organizing a portfolio of financial instruments is a software program interfaced with said financial instrument analytical software program.

21. A system for organizing a portfolio of financial instruments with a computer comprising:
a component for providing a first user interface for said portfolio of financial instruments;
a component for providing a second user interface for selecting a least one of said financial instruments of said portfolio to form a subset, said subset of said portfolio of financial instruments being formed based on user selected financial criteria of said portfolio of financial instruments in conjunction with at least one of the subset forming rules of financial criteria exclusion, single financial criteria inclusion, and multiple financial criteria inclusion; and
a component for reflecting the inclusion of said at least one of said financial instruments of said portfolio within said subset on said first user interface.

22. The system of claim 21 wherein said financial instruments of said portfolio within said subset are visually hi-lighted.

23. The system of claim 22 wherein said visual highlighting differentiates between said subset forming rules of financial criteria exclusion, single financial criteria inclusion and multiple financial criteria inclusion.

24. The system of claim 21 wherein said user selected financial criteria is obtained from a financial instrument analytical software program.

25. The system of claim 24 wherein said method of organizing a portfolio of financial instruments is a software program interfaced with said financial instrument analytical software program.

26. A system for organizing a portfolio of financial instruments with a computer comprising:
a component for providing communication by said computer with at least one financial instrument trading exchange for actions regarding said financial instruments;
a component for providing a first user interface for said portfolio of financial instruments;
a component for providing a second user interface for selecting a least one of said financial instruments of said portfolio to form a subset, said subset of said portfolio of financial instruments formed based on user selected financial criteria of said portfolio of financial instruments in conjunction with at least one of the subset forming rules of financial criteria exclusion, single financial criteria inclusion, and multiple financial criteria inclusion;
a component for reflecting the inclusion of said at least one of said financial instruments of said portfolio within said subset on said first user interface; and
a component for performing at least one of said actions in said financial instrument trading exchange for at least one of said financial instruments based on said financial instrument being in said subset of said portfolio.

27. The system of claim 26 wherein said financial instruments of said portfolio within said subset are visually hi-lighted.

28. The system of claim 27 wherein said visual highlighting differentiates between said subset forming rules of financial criteria exclusion, single financial criteria inclusion and multiple financial criteria inclusion.

29. The system of claim 26 wherein said user selected financial criteria is obtained from a financial instrument analytical software program.

30. The system of claim 29 wherein said system of organizing a portfolio of financial instruments is a software program interfaced with said financial instrument analytical software program.
